(19) United States
(12) Patent Application Publication
(10) Pub. No.: US 2015/0169103 A1
(43) Pub. Date: Jun. 18, 2015

(54) TOUCH DISPLAY APPARATUS

(71) Applicant: Chunghwa Picture Tubes, LTD., Taoyuan (TW)

(72) Inventor: Chang-Xin Huang, Taipei City (TW)

(73) Assignee: Chunghwa Picture Tubes, LTD., Taoyuan (TW)

(21) Appl. No.: 14/187,344

(22) Filed: Feb. 24, 2014

(30) Foreign Application Priority Data
Dec. 17, 2013 (TW) 102146721

(51) Int. Cl. G06F 3/044

(52) U.S. Cl. CPC G06F 3/044

(57) ABSTRACT

A touch display apparatus is provided. Touch scanning is executed through gate scan lines instead of being executed through touch scan lines.

### CROSS-REFERENCE TO RELATED APPLICATION

This application claims the priority benefit of Taiwan application serial no. 102146721, filed on Dec. 17, 2013. The entirety of the above-mentioned patent application is hereby incorporated by reference herein and made a part of this specification.

### BACKGROUND OF THE INVENTION

1. Field of the Invention

The invention relates to an electronic apparatus, and particularly relates to a touch display apparatus.

2. Description of Related Art

With the technical developments of touch panels, touch panels have been widely applied in the displays of electronic apparatuses, such as cell phones, laptops, or tablet computers. Touch panels allow the users to input or operate in a more convenient manner and make the user interface more user-friendly and convenient.

Based on different sensing types, touch panels are generally categorized into resistance touch panels, capacitive touch panels, optical touch panels, acoustic-wave touch panels and electromagnetic touch panels. The capacitive touch sensing panels are characterized by a short response time, favorable reliability, satisfactory durability, and so on. Therefore, the capacitive touch sensing panels are widely used in the electronic products.

The capacitive touch panels are operated by approaching or touching the touch panels with a finger or a conductive material to change capacitances of the touch panels. While variations in the capacitances are detected, the location approached or touched with the finger or the conductive material is determined, and an operation corresponding to the approached or touched location is performed. Generally speaking, an electrode structure of a capacitive touch panel includes a plurality of receiving electrodes and a plurality of driving electrodes. In practical use, the driving electrodes are used to receive a driving signal to drive the touch panel to sense the user's touch. The receiving electrodes are configured to generate a sensing signal in correspondence with a sensing signal of the user's touch.

The structure of the conventional capacitive touch panel already satisfies the users' needs. However, it is still desirable for the manufacturers to further reduce the manufacture cost of capacitive touch panels under the premise that the product quality is not influenced to make more profit.

### SUMMARY OF THE INVENTION

The invention provides a touch display apparatus capable of reducing a manufacturing cost and increasing a yield rate of the touch display apparatus.

The touch display apparatus of the invention includes a plurality of gate scan lines, a scan line driving unit, a touch electrode pattern layer, and a control unit. In addition, the scan line driving unit is coupled to and drives the plurality of the gate scan lines. The touch electrode pattern layer includes a plurality of electrode patterns. The control unit is coupled to a plurality of electrode series formed of the plurality of electrode patterns and the scan line driving unit to control the scan line driving unit to drive the plurality of gate scan lines, receives a touch sensing signal corresponding to an input tool from the electrode patterns corresponding to the gate scan lines that are driven, and determines a touch position of the input tool accordingly.

In an embodiment of the invention, the control unit includes an active array substrate, a touch chip, and a timing controller. The active array substrate is disposed below the touch electrode pattern layer, and the plurality of gate scan lines are disposed on the active array substrate. The touch chip is coupled with a plurality of electrode series. The timing controller is coupled to the scan line driving unit and the touch chip to control the scan line driving unit to sequentially drive the gate scan lines, and control the touch chip to sense the touch sensing signal according to a driving timing sequence of the gate scan lines to determine the touch position of the input tool accordingly.

In an embodiment of the invention, each of the electrode patterns and at least one corresponding of the gate scan lines form a touch sensing unit, and the plurality of the touch sensing units are configured to sense a touch of the input tool to generate the corresponding touch sensing signal.

In an embodiment of the invention, each of the electrode patterns corresponds to different numbers of the gate scan lines.

In an embodiment of the invention, some of the electrode patterns correspond to the same number of the gate scan lines, whereas some of the electrode patterns correspond to different numbers of the gate scan lines.

In an embodiment of the invention, the touch display apparatus further includes a color filter layer and a plurality of touch electrode lines. The color filter layer is disposed between the active array substrate and the touch electrode pattern layer. The plurality of touch electrode lines are disposed on the color filter. Each of the touch electrode lines is connected to a corresponding of the gate scan lines with a conductive bonding material. Each of the electrode patterns and at least one corresponding of the touch electrode lines form a touch sensing unit. The plurality of touch sensing units are configured to sense a touch of the input tool to generate the corresponding touch sensing signal.

In an embodiment of the invention, the conductive bonding material includes a silver paste, copper paste, carbon paste, nano silver, or a conductive polymer material.

In an embodiment of the invention, each of the electrode patterns corresponds to different numbers of the touch electrode lines.

In an embodiment of the invention, some of the electrode patterns correspond to the same number of the touch electrode lines, whereas some of the electrode patterns correspond to different numbers of the touch electrode lines.

Based on the foregoing, the embodiments of the invention utilize the gate scan lines to replace touch scan lines for touch scanning. Therefore, the touch chip is not required to have the function of driving the touch scan lines. As a result, the manufacture cost of the touch display apparatus may be reduced and the yield rate thereof may be increased.

### BRIEF DESCRIPTION OF THE DRAWINGS

FIG. 1 is a schematic view illustrating a touch display apparatus according to an embodiment of the invention.

FIG. 2 is a schematic waveform illustrating driving signals of gate scan lines and a touch sensing signal of electrode series of the embodiment shown in FIG. 1.

FIG. 3 is a schematic view illustrating a touch display apparatus according to another embodiment of the invention.

FIG. 4 is a schematic waveform illustrating driving signals of gate scan lines and a touch sensing signal of electrode series of the embodiment shown in FIG. 3.

FIG. 5 is a schematic view illustrating a touch display apparatus according to another embodiment of the invention.

FIG. 6 is a schematic view illustrating a touch display apparatus according to another embodiment of the invention.

### DESCRIPTION OF THE EMBODIMENTS

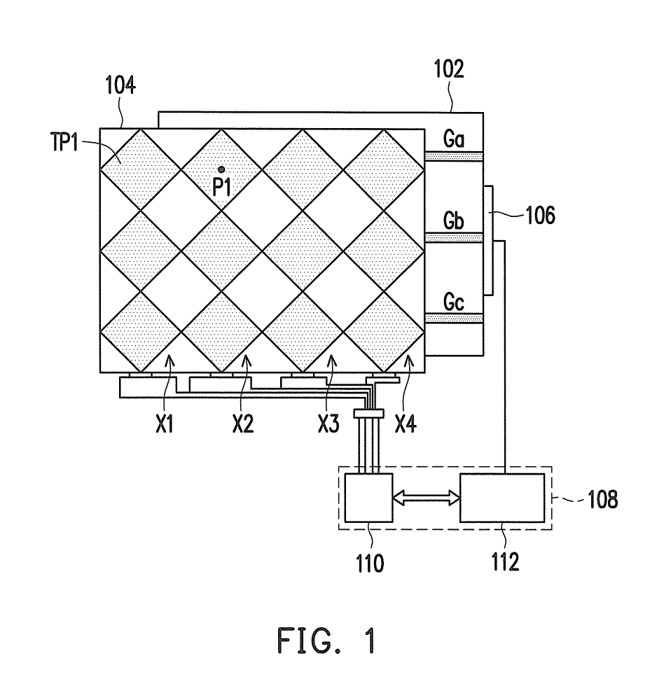

FIG. 1 is a schematic view illustrating a touch display apparatus according to an embodiment of the invention. Referring to FIG. 1, the touch display apparatus includes an active array substrate 102, a touch electrode pattern layer 104, a scan line driving unit 106, and a control unit 108. Wherein, the active array substrate 102 is configured below the touch electrode pattern layer 104, the scan line driving unit 106 may be integrated onto the active array substrate 102 as shown in FIG. 1 or be disposed externally with respect to the active array substrate 102. A plurality of gate scan lines Ga-Gc, a plurality of data lines (not shown), and a plurality of pixel units (not shown) are disposed on the active array substrate 102. Each of the pixel units is coupled with a corresponding of the gate scan lines and data lines. In addition, the touch electrode pattern layer 104 includes a plurality of electrode patterns TP1. The electrode patterns TP1 and the corresponding gate scan lines Ga-Gc form touch sensing units to sense a touch of an input tool (e.g. a finger or a touch pen) and generate a corresponding touch sensing signal.

It should be noted that in order to keep the drawings concise and focus on an emphasized part of the embodiment of the invention, elements such as the data lines and pixel units are not shown in FIG. 1. In addition, the gate scan lines for forming the touch sensing units are shown with the three gate scan lines Ga-Gc as a representative. Besides, only twelve of the electrode patterns TP1 and four electrode series X1-X4 thereby formed are shown. Numbers of the electrode patterns TP1, the electrode series, the gate scan lines, and sensing signal transmission lines in actual practice are not limited thereto.

The control unit 108 is coupled with the scan line driving unit 106 and the electrode series X1-X4. The control unit 108 controls the scan line driving unit 106 to drive the gate scan lines Ga-Gc. When the gate scan lines Ga-Gc on the active array substrate 102 are driven, the pixel units corresponding to the gate scan lines Ga-Gc may receive a pixel voltage through the data lines to display an image corresponding to the pixel voltage. Besides, the touch sensing units formed of the gate scan lines Ga-Gc that are driven and the corresponding electrode patterns TP1 is also enabled to sense a touch operation of the input tool, thereby generating the corresponding touch sensing signal. After the control unit 108 receives the touch sensing signal from the electrode patterns TP1, a touch location of the input tool may be determined accordingly.

More specifically, the control unit 108 may include a touch chip 110 and a timing controller 112, as shown in FIG. 1. The timing controller 112 is coupled with the touch chip 110 and the scan line driving unit 106, and the touch chip 110 is further coupled with the electrode series X1-X4. The timing controller 112 is configured to control the scan line driving unit 106 to sequentially drive the gate scan lines Ga-Gc, and controls the touch chip 110 to sense the touch sensing signal according to a driving timing sequence of the gate scan lines Ga-Gc and accurately determine the touch location of the input tool accordingly.

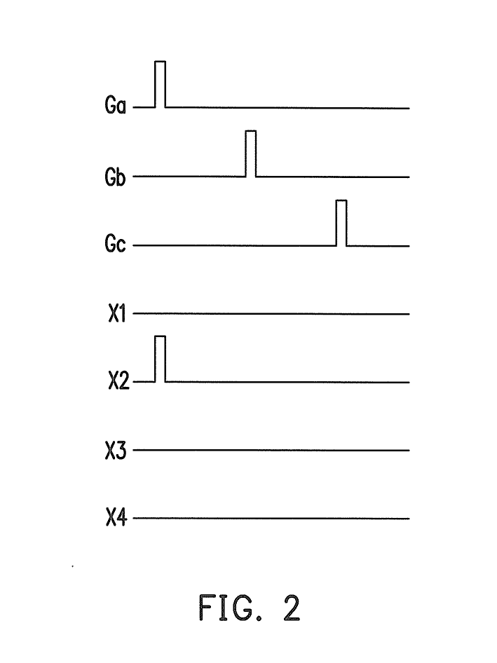

For example, FIG. 2 is a schematic waveform illustrating driving signals of the gate scan lines and the touch sensing signal of the electrode series of the embodiment shown in FIG. 1. Referring to FIGS. 1 and 2 simultaneously, given that the touch position of the input tool in this embodiment is P1, then only the electrode series X2 in the electrode series X1-X4 is found to reveal a change in voltage level in correspondence with a period that the gate scan line Ga is driven after the gate scan lines Ga-Gc are driven. Therefore, the touch chip 110 determines that the touch position of the input tool is P1 accordingly.

It should be noted that not all of the gate scan lines on the active array substrate 102 serve to form the touch sensing units with the electrode patterns TP1. In actual practice, it is feasible to choose gate scan lines with a preferable manufacture quality to form the touch sensing units with the electrode patterns TP1 at a design stage. Taking this embodiment for example, only the gate scan lines Ga-Gc are chosen to form the touch sensing units with the electrode patterns TP1, and the rest of the gate scan lines only serve to drive the pixel units to display an image. Also, the touch display chip 110 only detects the touch sensing signal when the chosen gate scan lines Ga-Gc are driven.

According to the above, in this embodiment, the gate scan lines are used to replace touch scan lines of the conventional technology. Therefore, the touch chip 110 is not required to have a function of driving the touch scan lines. Namely, a circuit and a pin for outputting a touch scanning signal need not to be manufactured, such that the touch chip 110 is miniaturized and a manufacture cost of the touch chip 110 is reduced. In addition, the touch scan lines are not required to be manufactured, either. Therefore, a manufacture cost is reduced and a yield rate is increased. Furthermore, since the driving signal on the gate scan lines has a voltage higher than a voltage of a driving signal of the conventional touch scan lines, an accuracy of identifying the touch location of the input tool may be facilitated.

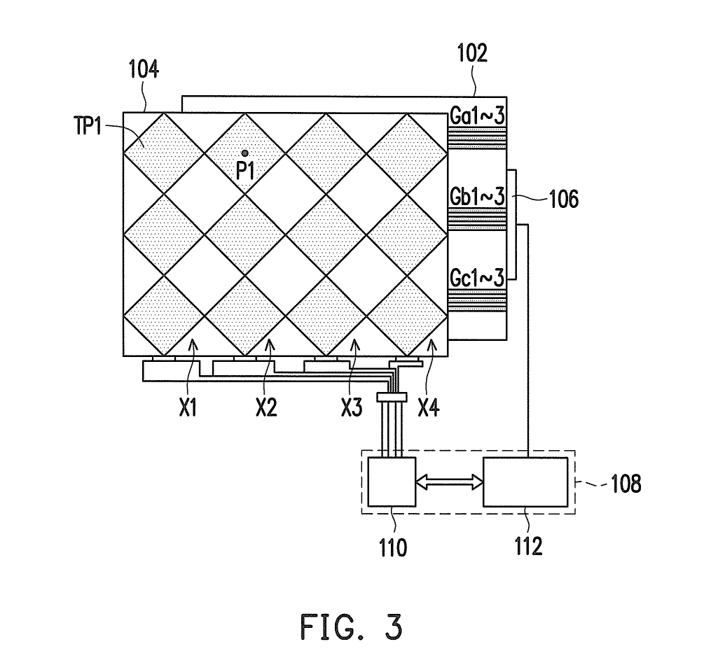

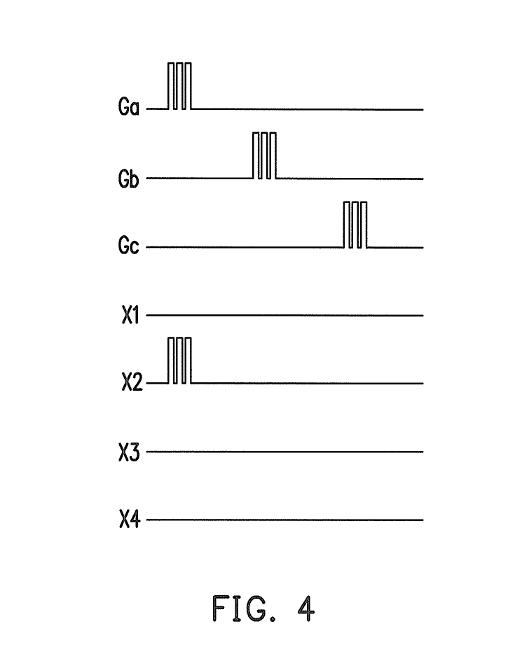

FIG. 3 is a schematic view illustrating a touch display apparatus according to another embodiment of the invention, and FIG. 4 is a schematic waveform illustrating driving signals of gate scan lines and a touch sensing signal of electrode series of the embodiment shown in FIG. 3. Referring to FIGS. 3 and 4 simultaneously, the touch display apparatus in the embodiment of FIG. 3 differs from the touch display apparatus in the embodiment of FIG. 1 in that a number of the gate scan lines that each of the electrode patterns TP1 corresponds to is increased to three, as represented by gate scan lines Ga1-3, Gb1-3, and Gc1-3, and the touch sensing signal corresponding to the gate scan lines Ga1-3, Gb1-3, and Gc1-3 is shown in FIG. 4. Increasing the gate scan lines that the electrode patterns TP1 correspond to increases the accuracy of determining the touch position of the input tool. When there is a problem for one single of the gate scan lines to transmit the driving signal, it is still possible to use the rest two of the gate scan lines to enable the touch sensing units formed of the electrode patterns TP1 and the gate scan lines for touch sensing. Given that the description with respect to a touch sensing operation is already provided in detail in the description of the touch display apparatus in the embodiment of FIG. 1, people having ordinary skills in the art may refer to the teachings of the embodiment of FIG. 1 to understand an operation of the touch display apparatus of the embodiment of FIG. 3. Therefore, no further details will be reiterated hereinafter.

Besides, it should be noted that in some embodiments, the electrode patterns TP1 may respectively correspond to different numbers of the gate scan lines. Alternatively, some of the electrode patterns TP1 may correspond to the same number of the gate scan lines, and some of the electrode patterns TP1 may correspond to different numbers of the gate scan lines. The designer may correspondingly adjust the number of the gate scan lines that each of the electrode patterns TP1 corresponds to, such that the design and application of the touch display apparatus are provided with more flexibility.

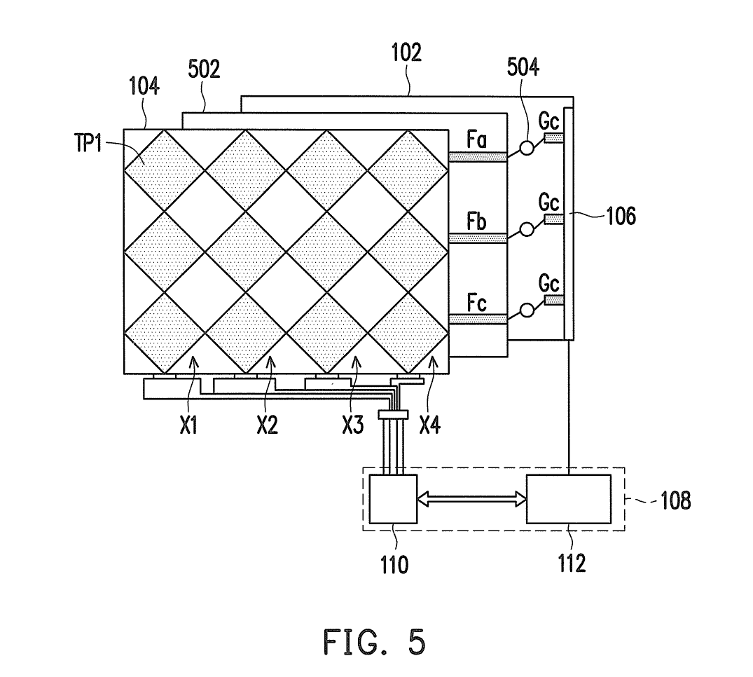

FIG. 5 is a schematic view illustrating a touch display apparatus according to another embodiment of the invention. Referring to FIG. 5, the touch display apparatus of this embodiment differs from the touch display apparatus shown in the embodiment of FIG. 1 in that the touch display apparatus of this embodiment further includes a color filter layer 502 disposed between the active array substrate 102 and the touch electrode pattern layer 104. A plurality of touch electrode lines Fa-Fc are disposed on the color filter layer 502, and each of the touch electrode lines Fa-Fc are connected to the corresponding gate scan lines Ga-Gc with a conductive bonding material 504. The conductive bonding material may be a silver paste, copper paste, carbon paste, nano silver, or a conductive polymer material. By configuring the touch electrode lines Fa-Fc that connect the gate scan lines Ga-Gc on the color filter 502, touch sensing units formed of the touch electrode lines Fa-Fc and the electrode patterns TP1 have a preferable sensitivity over that of the touch sensing units formed of the gate scan lines Ga-Gc and the electrode patterns TP1 in the embodiment shown in FIG. 1, while the chip 110 is still miniaturized and the manufacture cost thereof is reduced. This is because the color filter 502 is closer to the touch electrode pattern layer 104 than the active array substrate 102. Accordingly, a touch quality of the touch display apparatus of this embodiment is more preferable than a touch quality of the touch display apparatus of the embodiment of FIG. 1.

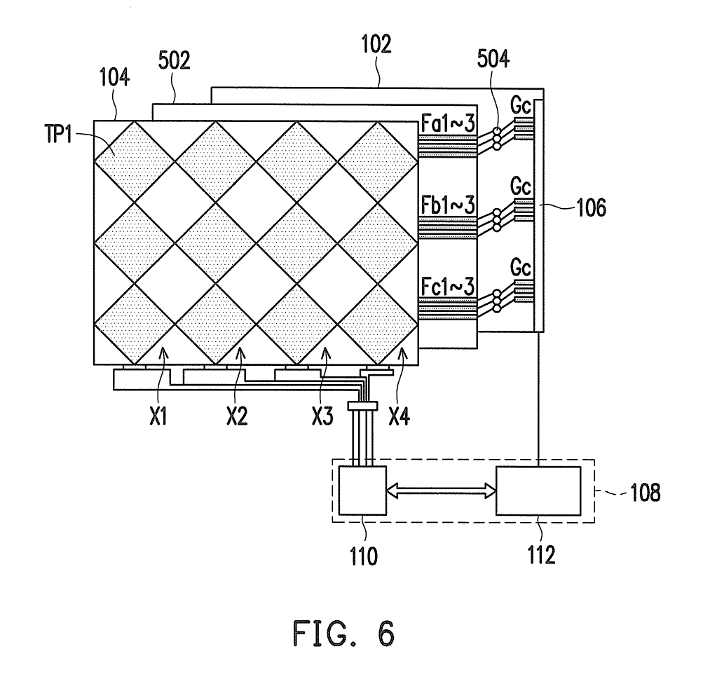

FIG. 6 is a schematic view illustrating a touch display apparatus according to another embodiment of the invention. Referring to FIG. 6, each electrode pattern TP1 of the touch display apparatus of this embodiment may correspond to three touch electrode lines represented as Fa1-3, Fb1-3, and Fc1-3, similar to the embodiment shown in FIG. 3, wherein, each of the touch electrode lines is also connected to a corresponding of the gate scan lines through the conductive bonding material 504. Besides, in some embodiments, the electrode patterns TP1 may respectively correspond to different numbers of the touch electrode lines. Alternatively, some of the electrode patterns TP1 may correspond to the same number of the touch electrode lines, whereas some of the electrode patterns TP1 may correspond to different numbers of the touch electrode lines, such that the design and application of the touch display apparatus are provided with more flexibility.

Given that the description with respect to the touch sensing operation is already provided in detail in the description of the touch display apparatus in the embodiments of FIGS. 1 and 3, people having ordinary skills in the art may refer to the teachings of the embodiments of FIGS. 1 and 3 to understand an operation of the touch display apparatus of the embodiments of FIGS. 5 and 6. Therefore, no further details will be reiterated hereinafter.

According to the above, in the invention, the gate scan lines are used to replace the touch scan lines for touch scanning. Therefore, the touch chip does not require to be manufactured with a circuit and a pin for outputting a touch scanning signal. Therefore, the touch chip may be miniatured and the manufacture cost of the touch chip may be reduced. In addition, since it is not necessary to additionally manufacture the touch scan lines, the manufacture cost is reduced and the yield rate is increased. Besides, since the driving signal on the gate scan lines has a higher voltage than that of the driving signal of the conventional touch scan lines, the accuracy of identifying the touch position of the input tool is increased. In some of the embodiments, the touch electrode lines may further be manufactured on the color filter layer to further improve the touch quality of the touch display apparatus.

What is claimed is:

1. A touch display apparatus, comprising:
a plurality of gate scan lines;
a scan line driving unit, coupled to and driving the gate scan lines;
a touch electrode pattern layer, comprising a plurality of electrode patterns; and
a control unit, coupled to a plurality of electrode series formed of the electrode patterns and the scan line driving unit, controlling the scan line driving unit to drive the gate scan lines, and receiving a touch sensing signal corresponding to an input tool from the electrode patterns corresponding to the gate scanning lines that are driven, and determining a touch position of the input tool accordingly.

2. The touch display apparatus as claimed in claim 1, wherein the control unit further comprises:
an active array substrate, disposed below the touch electrode pattern layer, wherein the gate scan lines are disposed on the active array substrate;
a touch chip, coupled to the electrode series; and
a timing controller, coupled to the scan line driving unit and the touch chip, controlling the scan line driving unit to sequentially drive the gate scan lines, and control the touch chip to sense the touch sensing signal according to a driving timing sequence of the gate scan lines to determine the touch position of the input tool accordingly.

3. The touch display apparatus as claimed in claim 1, wherein each of the electrode patterns and at least one of the gate scan lines form a touch sensing unit, and the touch sensing units are configured to sense a touch of the input tool to generate the corresponding touch sensing signal.

4. The touch display apparatus as claimed in claim 1, wherein each of the electrode patterns corresponds to different numbers of the gate scan lines.

5. The touch display apparatus as claimed in claim 1, wherein some of the electrode patterns correspond to the same number of the gate scan lines, whereas some of the electrode patterns correspond to different numbers of the gate scan lines.

6. The touch display apparatus as claimed in claim 2, further comprising:
a color filter layer, disposed between the active array substrate and the touch electrode pattern layer; and
a plurality of touch electrode lines, disposed on the color filter layer, wherein each of the touch electrode lines is connected to a corresponding of the gate scan lines with a conductive bonding material, each of the electrode patterns and at least one corresponding of the touch electrode lines form a touch sensing unit, and the touch sensing units are configured to sense a touch of the input tool to generate the corresponding touch sensing signal.

7. The touch display apparatus as claimed in claim 6, wherein the conductive bonding material comprises a silver paste, copper paste, carbon paste, nano silver, or a conductive polymer material.

8. The touch display apparatus as claimed in claim 6, wherein each of the electrode patterns corresponds to different numbers of the touch electrode lines.

9. The touch display apparatus as claimed in claim 6, wherein some of the electrode patterns correspond to the same number of the touch electrode lines, whereas some of the electrode patterns correspond to different numbers of the touch electrode lines.
